(19) United States
(12) Patent Application Publication
(10) Pub. No.: US 2017/0338020 A1
(43) Pub. Date: Nov. 23, 2017

(54) ACTUATOR ARRAYS FOR PRESSURE FEEDBACK SYSTEMS

(71) Applicants: William G. LAWLER, San Antonio, TX (US); Nadia M. Roumanos, Shelton, CT (US)

(72) Inventors: William G. LAWLER, San Antonio, TX (US); Nadia M. Roumanos, Shelton, CT (US)

(21) Appl. No.: 15/601,316

(22) Filed: May 22, 2017

Related U.S. Application Data
(60) Provisional application No. 62/339,919, filed on May 22, 2016.

(51) Int. Cl. H01F 7/16; H01F 7/122

(52) U.S. Cl. CPC H01F 7/1615; H01F 7/122; H01F 7/16

(57) ABSTRACT

Variable pressure feedback using solenoid-based actuators. Actuators positioned proximate the surface a user's body can include a deflectable armature and a coiled wire to deflect the armature to apply pressure to the user's body surface. A method can control such actuators to apply a respective level of pressure to the user's body surface. Additionally or alternatively, actuators positioned proximate the user's body surface can include solenoid(s) configured for activation, by at least one electrical signal, to generate, for each solenoid, a respective magnetic field and apply a corresponding pressure to the user's body surface. Activation of a solenoid can repel magnetic material to provide the pressure against the user's body surface, or cause the solenoid (or solenoid core thereof) to repel away from magnetic material and toward the user's body surface to apply pressure thereto.

### BACKGROUND

Aspects described herein relate to the technical fields of tactile stimulation and pressure feedback systems.

The field of haptic technology has for decades been focused on providing vibrational feedback to users. However, only a very few technologies have focused on giving pressure feedback to a person, despite the fact that people primarily interpret the sensation of touch to mean pressure, not vibration. In the last decade, there have been a number of “gloves” or systems designed to provide haptic feedback to a wearer, many of these have utilized vibrational motors to convey sensations, not pressure applicators. It is believed that the reason for the lack of pressure feedback in these various haptic systems is the difficulty of implementing a system to provide pressure output. For instance, to create a realistic sense of touch and create a system without tactile dissonance (for example, a delay between when you should feel something and when the output is given by the system) requires a low latency control system. Some systems have been developed to use pressure bladders to create pressure feedback, but these systems are slow and impractical for providing immersive tactile feedback. Solenoid actuators, despite having incredibly quick response times, have been overlooked for this application due to high costs and the weight of the actuators which, in prior art systems, can make them uncomfortable on a wearable system.

Accordingly, there is a need for improved tactile stimulation devices, systems, and methods, for example, to provide tactile feedback, that address or overcome the deficiencies of the prior art.

### SUMMARY

Shortcomings of the prior art are overcome and additional advantages are provided. In an embodiment, a system for providing tactile sensation is provided, the system including one or more actuators configured for positioning proximate a surface of a body of a user. Each actuator of the one or more actuators includes a deflectable armature; and a coiled wire configured to deflect the armature, based on an electrical signal, to apply pressure to the surface of the body of the user.

In another embodiment, a method for providing tactile sensation to a user is provided, the method including controlling one or more actuators to apply, for each actuator of the one or more actuators, a respective pressure to a surface of a body of a user. Each actuator of the one or more actuators includes a deflectable armature; and a coiled wire configured to deflect the armature, based on an electrical signal, to apply the respective pressure to the surface of the body of the user, wherein the controlling includes, for each actuator of the plurality of actuators, activating deflection of the respective armature to apply the respective pressure.

In yet another embodiment, a system for providing tactile sensation is provided, the system including one or more actuators configured for positioning proximate a surface of a body of a user. Each actuator of the one or more actuators includes one or more solenoids configured for activation, by at least one electrical signal, to generate, for each solenoid of the one or more solenoids, a respective magnetic field and apply a corresponding pressure to the surface of the body of the user; and a housing at least partially containing the one or more solenoids, wherein activation of each solenoid of the one or more solenoids is independently controllable from activation of any other solenoids of the one or more solenoids.

Another embodiment of the present invention may be a system that uses light-weight variable displacement solenoid actuators to provide pressure feedback to a user from a program or simulation. The solenoid actuators used in the system can be composed of a plastic bobbin and casing with a magnetic armature to offset the magnetic field losses from the plastic bobbin and casing and produce a more powerful force output. The actuator can also contain either a spring, a metallic back-plate or a rubber lining to provide antagonistic force and create a variable output. The actuator may be easily controllable by a pulse width modulation (PWM) or analog output circuit and can output a variable amount of pressure based on the received input. These actuators may also be designed to be sewn onto/attached to a wearable system (for example, a glove or a shirt). A number of these actuators may be arranged into an array to create a full pressure output system to a user.

Another embodiment of the invention may be a system for providing tactile sensation to a user, the system comprising or including: one or more actuators adapted to be mounted to the skin of a user, each of the one or more actuators comprising: a cap having an inner space to contain the armature and; a deflectable armature mounted in the cap; and a solenoid adapted to deflect the armature in response to an electrical signal; wherein contact between the deflected armature and the user's skin transmits at least load to the skin of the user. In one aspect, the system can further comprise a plunger that is deflectable in response to the solenoid. In another aspect, the system can further comprise a bobbin adapted to receive wires of the solenoid, for example, the bobbin may include a hole adapted to receive the plunger. In another aspect, the cap can comprise a hollow cylindrical structure adapted to receive the armature. In another aspect, system may further include an antagonistic device adapted to restrict deflection of the armature, for example, one or more springs or an elastomeric membrane. In a further aspect, the system may also include a piece of apparel, for example, a glove adapted to receive the one or more actuators. The system may also include a control system configured to operate the one or more actuators.

Another embodiment of the invention may be a method for providing tactile sensation to a user, the method comprising or including: mounting one or more actuators to transmit a load to the skin of a user, each of the one or more actuators comprising or including: a cap having an inner space to contain the armature ; a deflectable armature mounted in the cap; and a solenoid adapted to deflect the armature in response to an electrical signal; wherein contact between the deflected armature and the user's skin transmits at least load to the skin of the user; activating the solenoid and thereby deflecting the armature; and transmitting the deflection of the armature as a load on the skin of the user. In one aspect, activating the solenoid may be practiced by energizing the solenoid with an electric current. In another aspect, transmitting the deflection of the armature to the user's skin may be practiced by deflecting a plunger using the armature being moved by solenoid and contacting the armature with the plunger. In one aspect, mounting the one or more actuators may comprise mounting the one or more actuators to apparel wearable by the user, for example, to a glove wearable on the hand of the user. In a further aspect, the method may include controlling operation of the solenoid with a controller, for example, controlling the operation of the controller in response to an input signal to the controller.

Another embodiment of the invention may be an actuator for providing tactile sensation to the user, the actuator comprising or including: a cap having an inner space to contain the armature; a deflectable armature mounted in the cap; and a solenoid adapted to deflect the armature in response to an electrical signal; wherein contact between the deflected armature or plunger and the skin of the user transmits at least load to the skin of the user. In one aspect, the actuator may further include a plunger that is deflectable in response to the solenoid. In another aspect, the actuator may further include a bobbin, cylindrical housing, adapted to receive wires of the solenoid; the bobbin may have a hole adapted to receive the plunger. In another aspect, the cap may comprise a hollow cylindrical structure adapted to receive the armature and the solenoid and secure them proximally to the skin of the user. The actuator may also include an antagonistic device adapted to restrict deflection of the armature or plunger, for example, at least one spring or an elastomeric membrane. In a further aspect, the actuator may include a control system configured to operate the one actuator, for example, a control system embedded in the actuator, or in wired or wireless communication with the actuator.

In some aspects, provided are devices, systems, and methods that provide pressure sensation, for example, for tactile feedback, to a user from a program or simulation. The devices, systems, and methods can use variable-displacement solenoid actuators composed of a plastic bobbin and casing with a magnetic armature to offset the magnetic field losses from the plastic bobbin and casing to produce a more powerful force output. The devices, systems, and methods may be designed to be integrated into a wearable product to provide accurate pressure feedback to a wearer.

### BRIEF DESCRIPTION OF THE DRAWINGS

FIG. 1 is a top axiometric perspective view of a finger-pad actuator bobbin according to one embodiment described herein;

FIG. 2 is a top plan view of the finger-pad actuator bobbin of FIG. 1;

FIG. 3 is a bottom view of the finger-pad actuator bobbin of FIG. 1;

FIG. 4 is a front elevation view of the finger-pad actuator bobbin of FIG. 1;

FIG. 5 is a bottom perspective view of the finger-pad actuator bobbin of FIG. 1.

FIG. 6 is a top axiometric perspective view of a palm actuator bobbin according to one embodiment described herein;

FIG. 7 is a bottom view of the palm actuator bobbin of FIG. 6;

FIG. 8 is a top plan view of the palm actuator bobbin of FIG. 6;

FIG. 9 is a front elevation view of the palm actuator bobbin of FIG. 6;

FIG. 10 is a bottom perspective view of the palm actuator bobbin of FIG. 6.

FIG. 11 is a top axiometric perspective view of the finger-pad actuator cap according to one embodiment described herein;

FIG. 12 is a top plan view of the finger-pad actuator cap of FIG. 11;

FIG. 13 is a front elevation view of the finger-pad actuator cap of FIG. 11.

FIG. 14 is a schematic control circuit that may be used to control the outputs of an aspect described herein.

FIG. 15 is an exploded view of one finger-pad actuator with parts described herein assembled and shown according to one embodiment described herein, in which a spring provides antagonistic force;

FIG. 16 is an exploded view of another finger-pad actuator with parts described herein assembled and shown according to one embodiment described herein, in which a metal back-plate and a spring provide antagonistic force;

FIG. 17 is an exploded view of another finger-pad actuator with parts described herein assembled and shown according to one embodiment described herein, in which a rubber or elastic membrane provides antagonistic force;

FIG. 18 is an example of an array of actuators according to aspects described herein, with the actuators placed on the palm-side of the hand;

FIG. 19 is an example of an array of actuators according to aspects described herein, with the actuators placed on the backside of the hand;

FIGS. 20-26 depict an example variable fingertip base according to aspects described herein;

FIG. 27 depicts a top axiometric perspective view of an example solenoid core, in accordance with aspects described herein;

FIG. 28 depicts a top view of the example solenoid core of FIG. 27;

FIG. 29 depicts a side view of the example solenoid core of FIG. 27;

FIGS. 30-32 depict example pressure-point bases, in accordance with aspects described herein;

FIG. 33 depicts an example pressure-point system utilizing a magnetic membrane to apply pressure, in accordance with aspects described herein;

FIGS. 34-35 depict another example pressure-point system, in accordance with aspects described herein; and

FIGS. 36-41 depict an example dynamic ferrofluid pressure system, in accordance with aspects described herein.

### DETAILED DESCRIPTION

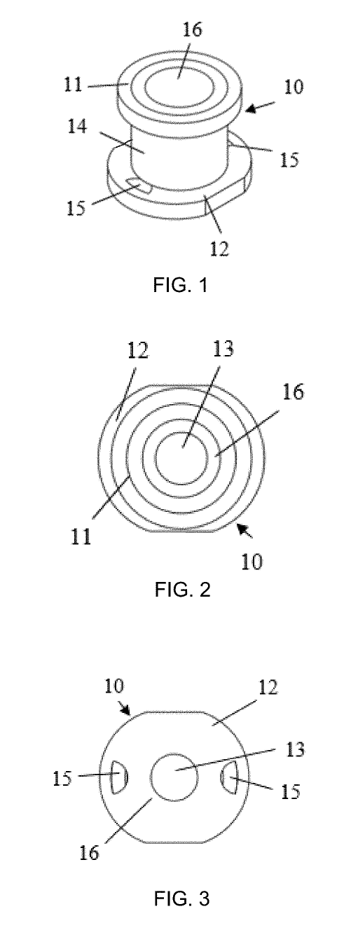

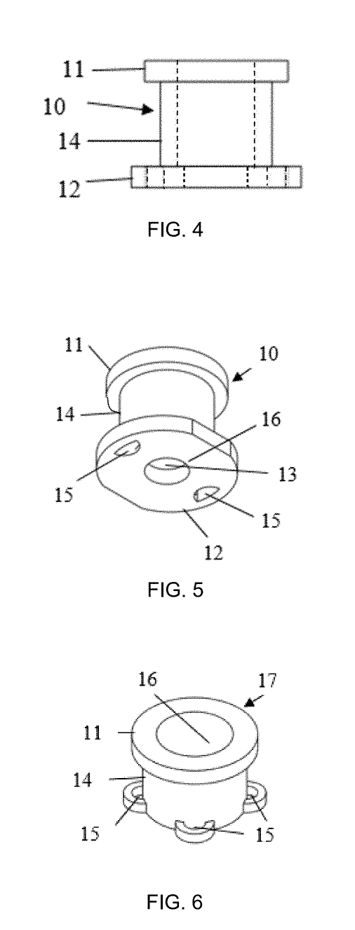

Referring now to aspects in more detail, in FIGS. 1-5 there is shown a finger-pad bobbin 10 designed for an actuator to be mounted on the finger-pad. The finger-pad bobbin 10 is comprised of a hollow spindle 14 mounted to a bottom flange 12 which forms the base of the finger-pad bobbin 10. The bottom flange 12 includes at least three holes (in this example), at least two “sewing” holes 15 for attaching the finger-pad bobbin 10 to a wearable system, for example, a strap or an article of clothing, and a guide hole 13. The guide hole 13 is located in substantially the center of the finger-pad bobbin 10 and may typically be concentric with the bobbin 10. The spindle 14 includes a larger diameter hole 16, adapted to receive an armature (not shown) contained in the body of the spindle 14. As also shown in FIGS. 1-5, bobbin 10 may typically include a top flange 11, for example, having an outer diameter greater than the diameter of the spindle 14. The top flange 11 may be positioned on the top of spindle 14, in this instance, the top flange 11 extends out the diameter of the spindle 14.

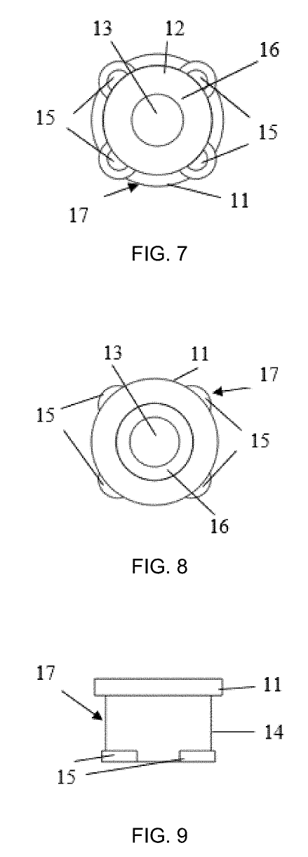

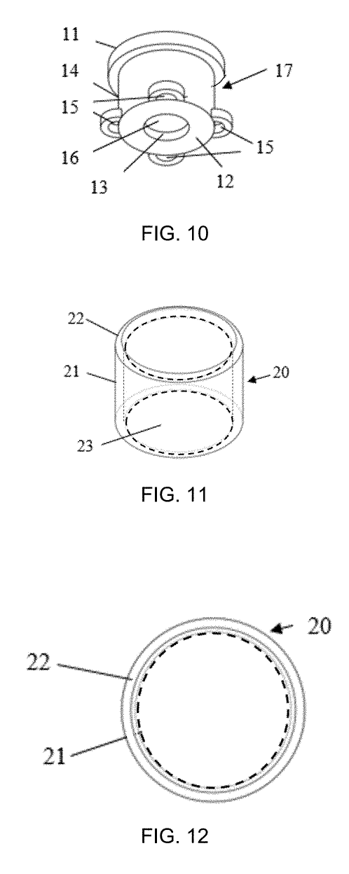

Referring now to aspects in more detail, in FIGS. 6-10 there is shown a palm bobbin 17 according to aspects described herein. Palm bobbin 17 may typically be designed and adapted for an actuator to be mounted on the palm of a hand of a human operator. In one aspect, the palm bobbin 17 may be very similar in design and construction to the finger-pad bobbin 10 shown in FIGS. 1-5. The palm bobbin 17 is comprised of a hollow spindle 14 mounted to a bottom layer 12 (for example, analogous to the bottom flange 12 shown in FIGS. 1-5), which forms the base of the palm bobbin 17. The bottom layer 12 may include one to five holes: a central guide hole 13 and two or more (for example four as shown) sewing holes 15. As shown, sewing holes 15 may comprise projections or “loops” that protrude from the bottom layer 12 or from spindle 14. These sewing holes 15 may typically be distributed around the spindle 14, for example, evenly distributed, such as, with a 90° spacing separating each of the four sewing holes 15, as shown in FIGS. 6-10. Smaller and larger spacing of sewing holes 15 are also envisioned, for example, 30 degrees, 60 degrees, 120 degrees, or 180 degree spacing is also envisioned. These sewing holes 15 are for attaching the palm bobbin 17 to a wearable system, for example, a strap, or an article of clothing. The guide hole 13 may typically extend substantially through the center of the palm bobbin's 17 bottom layer 12 and may typically be concentric with a larger diameter hole 16 for the armature (not shown) contained in the body of the spindle 14. As is also shown in FIGS. 6-10, palm bobbin 17 may typically include a top flange 11, for example, having an outer diameter greater than the diameter of the spindle 14, may be positioned on the top of the spindle 14, for instance, the top flange 11 extends out the diameter of the spindle 14.

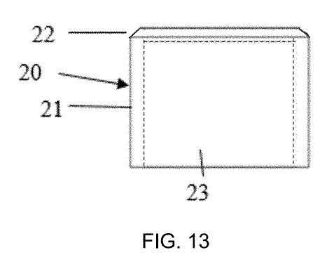

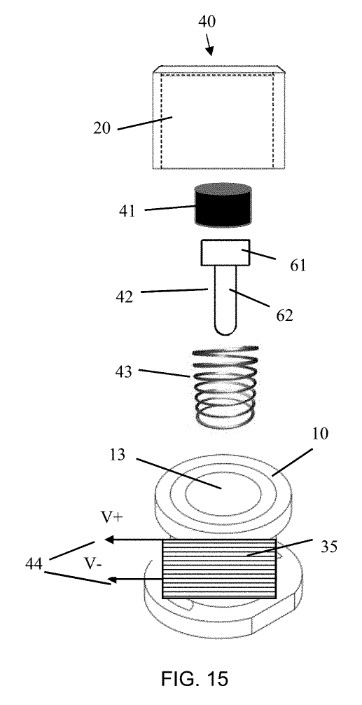

Referring now to FIGS. 11-13, there is shown a cap 20 that may be used for a finger-pad actuator according to an aspect of the invention. Cap 20 includes a cylindrical body 21 with a substantially hollow interior 23 adapted to contain an actuator system (not shown, see item 40 in FIGS. 15-17), the upper edge of the cylindrical body 21 may include a chamfer or a fillet 22 on it.

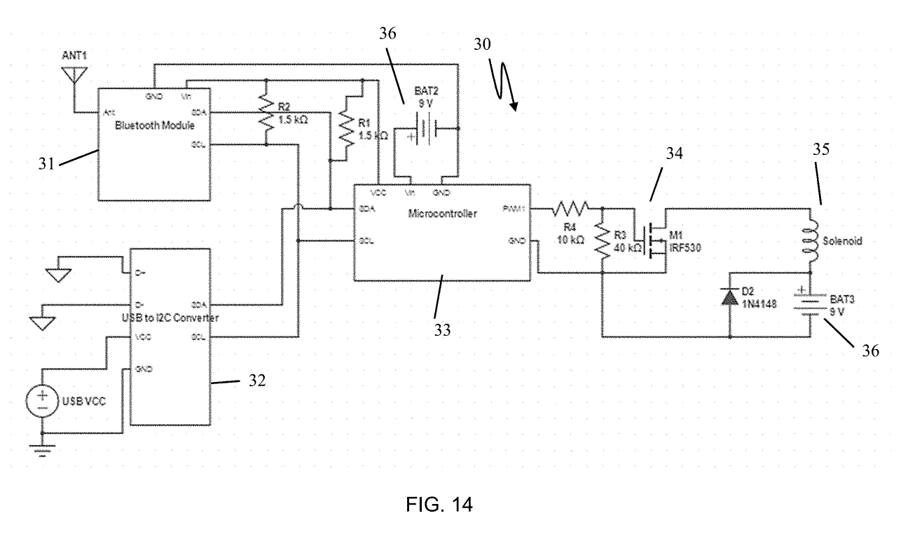

Referring now to FIG. 14, there is shown a simplified schematic control circuit 30 that may be used for one of the actuator systems 40 (see FIGS. 15-17) according to aspects described herein. In one sequence, the control sequences may start by reading input through an input module 31, for example, either a Bluetooth (or other wireless connection) module 31 or a wired input, for example, USB input 32. Input 31 and/or input 32 may then employ any conventional signal protocol, to a microcontroller 33, for example, using I2C protocol (as shown in FIG. 14) or any other data sending protocol suitable for communicating with a microcontroller 33. Microcontroller 33 may typically be connected to an electronic switch 34, for example, a Metal-oxide Semiconductor Field-effect Transistor (MOSFET) switch, or its equivalent. Switch 34 typically controls the current flow through a solenoid windings 35 associated with, for example, mounted in, actuator 40 (see FIGS. 15-17). Circuit 30 may be powered by any conventional power supply, including photovoltaic cells or power from the grid; however, as shown in FIGS. 14, circuit 30 may typically powered by one or more batteries 36, for example, one or more 9 V batteries or their equivalent.

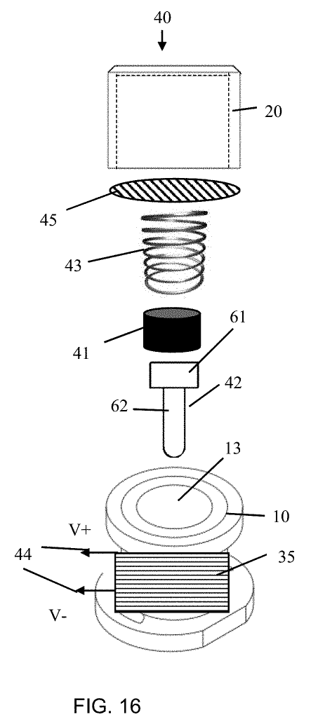

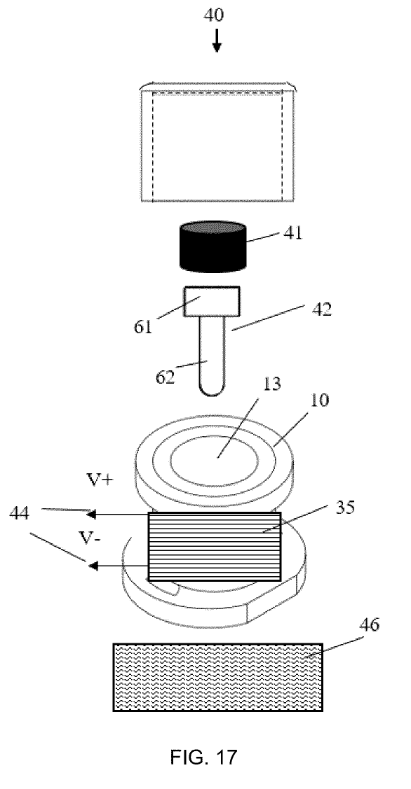

Referring now to FIGS. 15-17, there are shown exploded views of three of aspects or three different variations of the finger pad solenoid assemblies 40 that may be used in aspects described herein. FIG. 15 is an exploded view of one finger-pad actuator with parts described herein assembled and shown according to one embodiment described herein, in which a spring provides antagonistic force; FIG. 16 is an exploded view of another finger-pad actuator with parts described herein assembled and shown according to one embodiment described herein, in which a metal back-plate and a spring provide antagonistic force; and FIG. 17 is an exploded view of another finger-pad actuator with parts described herein assembled and shown according to one embodiment described herein, in which a rubber or elastic membrane provides antagonistic force. As shown, all three variations may be contained by a cap piece 20 (for example, the cap pieces shown and described with respect to FIGS. 11-13) and contain a finger-pad bobbin 10 (for example, the bobbin shown and described with respect to FIGS. 1-5). According to aspects described herein, bobbin 10 may typically be wrapped in a solenoid or magnet wire loops 35 connected to electrical leads 44. In one aspect, or the first variation of actuator 40 shown in FIG. 15, actuator 40 includes a permanent magnet 41, which functions as an armature of actuator 40, positioned above a plunger 42 which is positioned to compresses a spring 43, for example, a coil spring, as plunger 42 travels (vertically, in the view of FIG. 15) through the guide hole 13 of bobbin 10. Plunger 42 may typically have a head 61 and a shaft 62, where the head 61 is greater in diameter than the diameter of the shaft 62.

In another aspect, or the second variation of actuator 40 shown in FIG. 16, the actuator 40 includes a ferromagnetic disk 45, for example, steel disk, positioned on or in the top of the cap piece 20 with a compression spring 43, for example, a coil spring, separating the ferromagnetic disk 45 from the permanent magnet armature 41 positioned above (in the view of FIG. 16) the plunger 42. Similar to the description of FIG. 15, in FIG. 16 bobbin 10 may typically be wrapped in a solenoid or magnet wire loops 35 connected to electrical leads 44. Plunger 42 travels (vertically, in the view of FIG. 16) through the guide hole 13 of bobbin 10. Plunger 42 may typically have a head 61 and a shaft 62, where the head 61 is greater in diameter than the diameter of the shaft 62.

In another aspect, or the third variation of actuator 40 shown in FIG. 17, the actuator 40 includes a permanent magnet armature 41 positioned within the cap 20 and above the plunger 42 with the addition of a layer of elastomeric, elastic, or rubbery material 46 positioned below or within the guide hole 13 in the path of the plunger 42. In FIG. 17, bobbin 10 may typically be wrapped in a solenoid or magnet wire loops 35 connected to electrical leads 44. Plunger 42 travels (vertically, in the view of FIG. 17) through the guide hole 13 of bobbin 10. Plunger 42 may typically have a head 61 and a shaft 62, where the head 61 is greater in diameter than the diameter of the shaft 62.

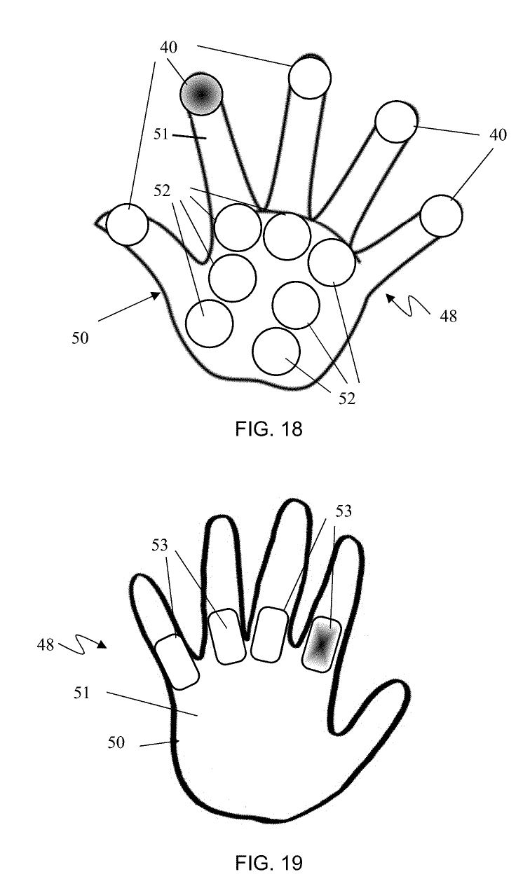

Referring now to FIGS. 18-19, according to aspects described herein, there is shown an example array 48 of the different solenoid assemblies 40, 52, and 53 (for example, similar to or substantially identical to solenoid assemblies 40 shown in FIGS. 15-17) and how assemblies 40, 52, and 53 contact and/or apply pressure to the hand 50 of a human user/operator. Assemblies 40, 52, and 53 may typically include finger-pad solenoid assemblies 40 (for example, shown in FIGS. 15-17), palm solenoid assemblies 52, and knuckle solenoid assemblies 53. In the aspect shown in FIGS. 18 and 19, there are sixteen total actuator assemblies 40, 52, and 53 attached to a glove 51 worn over the hand 50. As shown in both FIGS. 18 and 19, to create the example actuator array 48, five (5) finger-pad solenoid assemblies 40, one on the tip of each finger of hand 50; four (4) knuckle solenoid assemblies 53, one on each knuckle (excluding the thumb); and seven (7) palm actuator assemblies 52 dispersed on the palm of the hand may be provided. In one aspect, three (3) palm actuator assemblies 52 may be positioned just below the fingers, two (2) palm actuator assemblies 52 may be provided on the space on the palm near the thumb, but before the crease close to the center of the palm, and two (2) more palm actuator assemblies 52 may be provided on the fatty portion of the palm on the opposite side of the thumb. Other arrangements of arrays 48 of actuator assemblies 40, 52, and 53 on hand 50 are also envisioned and may be apparent to those of skill in the art, for example, depending upon the size of hand 50 and/or the expected location of contact of hand 50 with specific sized or shaped structures.

In each of FIGS. 18 & 19, one actuator is shown having a visually-depicted pressure gradient, in which areas of greater pressure (applied by way of the actuation of the plunger of the actuator, as an example) are presented by darker portions of the pressure gradient; in other words, the greater the pressure applied to a given area, the darker that portion of the gradient over that area will be shown. It is seen that the greatest pressure is applied in substantially the center area of the actuator, and the pressure applied decreases extending in all directions from the center area of the actuator.

According to further aspects described herein, for example, in more detail, referring to the aspects and parts of aspects shown in FIGS. 1-5, the spindle 14 of the finger-pad bobbin 10 may be used to wrap the solenoid coil of magnet wire 35 (i.e. the magnet wire may be wrapped around the spindle) and bobbin 10 may contain the path/hole 16 for the armature 41 and plunger 42, for example, hole 16 may guide the travel of armature 41, and plunger 42 may typically pass through and be guided by the smaller diameter guide hole 13. In one aspect, guide hole 13 may serve to keep the head (61 in FIGS. 15-17) of plunger 42 in the finger-pad bobbin 10, the head 61 of the plunger 42 having a diameter greater than that of the guide hole 13 but less than the diameter of the armature hole 16. In one aspect, the bottom flange 12 of bobbin 10 may serve as the base plate for the finger-pad bobbin 10, for example, with the sewing holes 15 allowing the bobbin 10 to be sewn, or otherwise attached or mounted, onto objects of clothing. In addition, the bottom flange 12 along with the top flange 11 may serve to vertically contain the wound solenoid coils of magnet wire 35.

According to further aspects, for example, in more detail, referring to the aspects and parts shown in FIGS. 6-10, the palm bobbin 17 may function in substantially the same way as the finger-pad bobbin 10. For example, according to one aspect, the only effective difference being that the palm bobbin 17 is larger and can simulate a higher level of pressure due to its greater size than the finger-pad bobbin 10 can simulate. The spindle 14 of the palm bobbin 17 may be used to wrap the solenoid coil of magnet wire 35 and palm bobbin 17 may contain the path/hole 16 for the armature 41 and plunger 42 to travel in. In a fashion similar to bobbin 10 described above, the smaller diameter guide hole 13 serves to keep the head 61 of plunger 42 in the palm bobbin 17. Again, the head 61 of the plunger 42 may typically have a diameter greater than that of the guide hole 13 but less than the diameter of the armature hole 16. Also, the bottom layer 12 of bobbin 17 (analogous to the bottom flange) may serve as the base plate for the palm bobbin 17. Again, the sewing holes 15, for example, four sewing holes, may typically protrude from the side of the palm bobbin's 17 bottom layer 12 to form a structure resembling a bottom flange 12. In one aspect, the sewing holes 15 protrusions along with the top flange 11 may assist in the winding of the solenoid coil of magnet wire 35 and contain the coil vertically. The sewing holes 15 may also allow the palm bobbin 17 to be sewn, or otherwise attached or mounted, onto objects of clothing.

According to further aspects, for example, in more detail, referring to the aspects or parts shown in FIGS. 11-13, the cap piece 20 of the actuator system 40 may serve to contain and/or protect the system components within the largely hollow interior 23 of the cap piece 20. In one aspect, the top edge 22 of the body 21 of the cap piece 20 may be chamfered or filleted to soften the edge 22 in case of contact with the wearer.

According to further aspects, for example, in more detail, referring to the aspects or parts shown in FIG. 14, the control circuit 30 (which is shown simplified) may serve to obtain output data from a program or simulation and use the output data as input to coordinate the response of the actuator system and may provide ancillary data, for example, a set displacements depending on the input received. In one aspect in the control circuit 30, the input module 31, for example, the Bluetooth/wireless communication module, and the input module 32, for example, the USB to I2C (or other sending protocol) converter may serve the substantially same function of taking input sent from a program or simulation and sending it onto the microcontroller 33. In one aspect, the USB converter 32 may provide the additional advantages or benefits of providing slightly quicker response times and the ability to charge the batteries 36. In another aspect, the microcontroller 33 may be adapted to determine whether or not there is a USB cable attached to the device. For example when a USB cable is attached, the microcontroller 33 may read data from the USB data converter 32, and, when there is not a USB attached, then the microcontroller 33 may read from the Bluetooth/wireless communication module 31. In either case, the microcontroller 33 is typically adapted to accept data and provide an electrical signal, for example, a 4V max pulse width modulated (PWM) signal, to an electronic switch or MOSFET 34. In response to the signal provided by microcontroller 32, the switch 34 typically controls the current flow from the power supply 36, such as, a nine-volt battery, to the solenoid magnet wire coil 35. In addition, during the output pulse width cycle from microcontroller 33, the MOSFET 34 may allow current to pass when the signal from the microcontroller 33 is “High” (for example, 4 volts (V)) and may stop the current when the signal is “Low' (for example, 0 V). According to aspects, this may control or regulate the operation of the solenoid actuator system 40 by establishing a duty cycle. For example, during a percentage of the time that current is flowing through the solenoid 35, the duty cycle then may establish the average magnetic field developed inside the magnet wire coils of the solenoid 35, which exerts a set force on the armature 41 of the solenoid which in turn displaces the plunger 42, thereby applying pressure to the wearer, for example, to the skin of the wearer.

According to further aspects, for example, in more detail, referring to the aspects or parts shown in FIGS. 15-17, the actuator system 40 may function in substantially the same way across all three FIGS. 15-17, but with different methods of applying “antagonistic” force—for example, the force resisting the displacement of the plunger by solenoid 35. According to one aspect, the application of an antagonistic force allows the actuator 40 to “reset itself” after the signal for the actuator to move the plunger has ended, terminated, or otherwise ceased to activate the actuator 40. In one aspect, the antagonistic force may also allow the actuator 40 to apply variable pressure to the wearer, for example, based on the amount of force generated by the magnetic field from the magnet wire coils of the solenoid 35 being applied to the permanent magnet armature 41. For example, in the first variation or aspect shown in FIG. 15, the antagonistic force is provided using the compression spring 43, the compression spring 43 having a diameter, for example, an inside diameter, greater than the diameter of the shaft 62 of the plunger 42, but the compression spring having a diameter, for example, an outside diameter, less than that of the armature path/hole 16. In one aspect, the spring 43 may be compressed and applies antagonistic force proportional to the displacement of the plunger 42 as the plunger 42 is forced down by the armature 41.

In the second variation or aspect shown in FIG. 16, antagonistic force may be created by a ferromagnetic back-plate 45, for example, a naturally or artificially magnetized plate, which, due to the presence of and/or deflection of the permanent magnet armature 41, pulls the armature 41 closer to the plate 45. However, in one aspect, spring 43 may bias the position of the armature 41 from attaching too strongly to the back-plate 45, except when current is allowed to flow through the solenoid wire coils 35, in which case, the ferromagnetic back-plate 45 may lose some of its magnetic strength due to the variation in magnetic field. In one aspect, variation of the electric field may actually contribute to strengthening the magnetic field generated by the solenoid wire coils 35, and, for example, push the permanent magnet armature 41 down causing the plunger 42 to displace and pressure to be applied.

The third variation or aspect shown in FIG. 17, the antagonistic force may be provided by using an elastic/rubbery membrane 46. For example, the membrane 46 may be placed across the exit or open bottom of the guide hole 13. In one aspect, when the magnetic field from the solenoid wire coils 35 forces the armature 41 to displace the plunger 42 down and through the guide hole 13, the elastic membrane 46 may displace with the plunger 42 and exerts an antagonistic or resistant force proportional to the amount the elastic membrane 46 is displaced.

According to an aspect, the size and shape of actuator 40 may vary depending upon, among other things, the size of the hand of the user and the parameters of its use. For example, the cap 20 and the bobbins 10 and 17 may have outside diameters or outside widths ranging from about 0.25 inches to about 6 inches, but are typically between about 0.4 inches and about 0.7 inches in diameter. The cap 20 and the bobbins 10 and 17 may have a height ranging from about 0.25 inches to about 6 inches, but the heights of these structures typically range between about 0.4 inches and about 0.7 inches.

In addition, according to aspects described herein, the cap 20 and the bobbins 10 and 17 may be metallic or non-metallic, for example, plastic. In one aspect, cap 20 and the bobbins 10 and 17 may be made from aluminum or other lightweight non-magnetic alloy. In one aspect, cap 20 and the bobbins 10 and 17 may be made from a plastic, for example, a polyamide (PA), for example, nylon; a polyethylene (PE), both high-density polyethylene (HDPE) and low-density polyethylene (LDPE); a polyethylene terephthalate (PET); a polypropylene (PP); a polyester (PE); a polytetrafluoroethylene (PTFE); a polystyrene (PS); an acrylonitrile butadiene styrene (ABS); a polycarbonate (PC); or a polyvinylchloride (PVC); among other plastics. For example, it is envisioned that cap 20 and the bobbins 10 and 17 may typically be made of Acrylonitrile butadiene styrene (ABS), or its equivalent.

According to further aspects, for example, in more detail, referring to the aspects or parts for which an example is shown in FIGS. 18-19, there are three different design variations or aspects of the solenoid actuator assembly 40, 52, 53 present in this example of a hand-based actuator array 48. This array 48 may be assembled on a glove 51 with the three solenoid actuator assemblies 40, 52, 53 operating in substantially the same manner, but being differentiated due to biological concerns associated with their location in the array 48 and on the hand 50. As shown in FIG. 18, the finger-pad actuator assemblies 40 may typically be the smallest in size and typically the least powerful, for example, it is envisioned that this may be due to both the thin dimensions of a finger and also to the increased sensitivity of the fingertips, for example, as compared to the rest of the hand. Accordingly, it is envisioned that less force may be needed to simulate pressures for finger-pad actuators 40.

The knuckle actuator assemblies 53 shown in FIG. 19 may typically be rectangular in shape, for example, rectangular cylindrical, though they may be circular or elliptical cylindrical. The shape of actuator assemblies 53 may be dictated by their position on the hand 51, because the plungers 42 in the actuators 53 apply pressure along the length of the knuckle. The palm actuator assemblies 52 shown in FIG. 18 may be larger than the finger pad actuator assemblies 40. For example, it is envisioned that the location on the palm can afford actuators 52 to be larger, and palm actuator assemblies 53 may need to apply a greater force to the palm to simulate pressures, for example, due to the recognized decreased sensitivity on the palm of the hand.

According to additional aspects, it is also envisioned that actuators 40, 52, and 53 and arrays 48 may be applied to other parts of the body, for example, to the arms, legs, back, chest, or head, and provide similar tactical pressure as disclosed herein. In addition, the magnitude of the pressure or force applied by actuators 40, 52, and 53 and arrays 48 may be varied according to the location of use and intended function. In one aspect, different actuator variations may be adapted to give tactile pressure feedback for different portions of the body, according to desired strength and size characteristics, and many different actuator arrays could be created.

The construction details as shown in the FIGS. 1-19 are that the bobbins 10, 17 and the cap pieces 20 (for all solenoid actuator assemblies 40, 52, 53) may be constructed of plastic or other lightweight material so as to not over-encumber the user. The microcontroller 33 may be able to take as input the communication protocol used by the input pieces (either of 31 or 32) and typically provide a pulse width modulated (PWM) output signal. The electronic switch or MOSFET 34 used may be adapted to operate at at least 100 milliamps (mA) of current, for example, from its “Drain” to “Source” pins and to pass sufficient amounts of current to power the solenoid wire coils 35. The solenoid wire coils 35 may typically be copper wire, for example, covered in an enamel insulating layer, and be of a length to create a resistance that, for example, maximizes voltage across the solenoid wire coil 35 length but also keeps the current through the wire less than 100 mA, for example, to avoid overheating/burning out the solenoid's wire coils 35. The armature 41 may be composed of a magnet, such as a permanent magnet, such as, neodymium, for example, neodymium of grades from 35 and up, to ensure solenoid actuator system 40 is capable to supply an adequate amount of pressure to the wearer.

In FIG. 15, spring 43 may typically have as low a spring constant as possible, for example, so as not to minimize the force of the solenoid actuator systems 40, 52, 53. However, as shown in FIG. 16, the spring 43 need not be limited in spring constant as spring 43 shown in FIG. 15. In one aspect, the spring 43 in FIG. 16 may only be a large enough length to prevent the magnetic armature 41 from attaching too strongly to the ferromagnetic back-plate 45. In FIG. 16 only, the plunger 42 shown may be ferromagnetic or attached, for example, physically attached, to the magnetic armature 41, for example, to allow the plunger 42 to travel with the armature 41. In another aspect, as shown in FIGS. 15-17, the plunger 42 may be composed of a material with high magnetic permeability, for example, to further increase the force of the solenoid actuator system 40, 52, 53. In another aspect, plunger 42 in FIG. 15-17 may be composed of plastic, for example, to decrease the weight of the solenoid actuator system 40, 52, and 53, depending on which is more appropriate.

In the example hand-based array 48 shown in FIGS. 18-19, the glove 51 may be of a material that is efficient at dissipating heat, for example, to decrease the potential damage in the extreme case of a component breakdown.

Advantages of embodiments and aspects described herein, can include, among other things, the ability to give accurate and variable tactile pressure feedback to a user, for example, in a way that is much quicker than other systems, for instance those involving hydraulics, and in a way that is much more intuitive than traditional vibrational motor feedback. The ability of aspects described herein to convey touch by simply applying a controlled amount of pressure to the wearer's body, for example, to the skin of the body, is much more intuitive than attempts to approximate touch sensations with varied vibrations generated by vibrational motors, among other approaches.

Accordingly, aspects described herein provide devices, systems, and methods that provide immersive tactile pressure feedback from both virtual and real world sources.

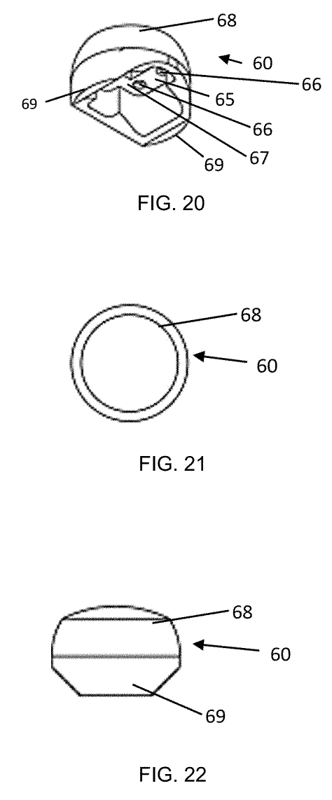

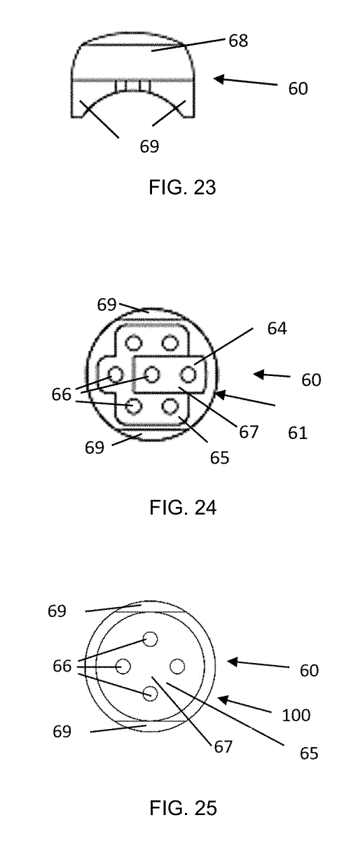

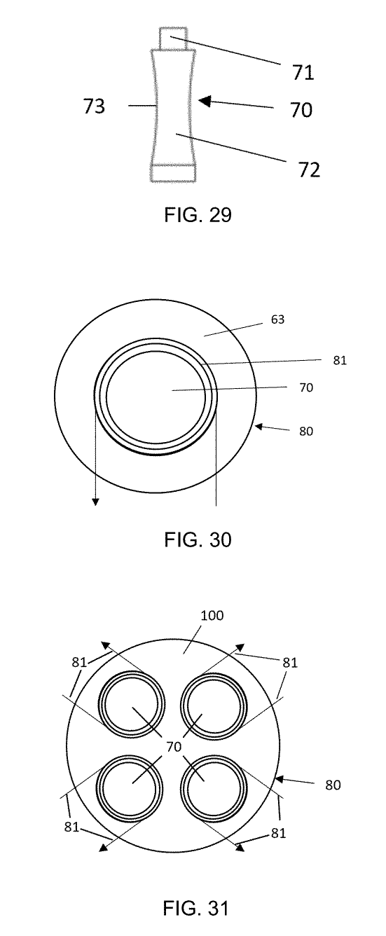

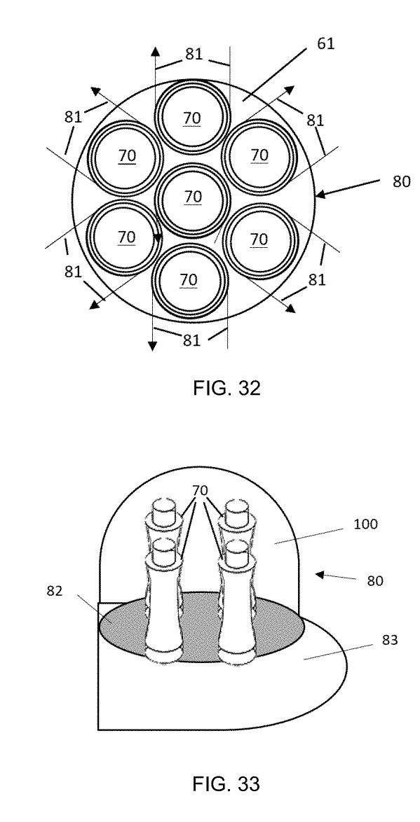

Further aspects are now described with reference to FIGS. 20-41. Initially, an example solenoid core is depicted in FIGS. 27-29, in which FIG. 27 depicts a top axiometric perspective view of an example solenoid core, FIG. 28 depicts a top view of the example solenoid core of FIG. 27, and FIG. 29 depicts a side view of the example solenoid core of FIG. 27. The solenoid core may be a miniaturized solenoid core made of plastic and wrapped by magnet wire to form a solenoid. This example model is relatively easy to make. The end of the solenoid core may be designed to fit into slots 66 of FIGS. 24-26 once they are properly wrapped. FIGS. 20-26 show several housings for a magnetic membrane embodiment, with the circular indents in the roof of the housing allowing the wrapped solenoid cores to be easily attached to/inserted into the ceiling of the housing. The housing may then be glued onto the finger of a thin rubber or nitrile glove (or any desired article) that has been laced with magnetic powder at least in the spots where the actuators are to be located, for purposes described further below. The wires/electrical leads coming from the solenoids can exit out of the bottom of the actuator housing and may be flush against the surface of the glove. This design may also be used in the making of a magnetic backplating embodiment but in this case the indents may be omitted and a magnet may be glued to the roof of the housing and a thin paper or plastic membrane put between the different solenoid cores (to separate them and reduce friction between them while they move). In the backplating embodiment again the housing may be attached to a rubber or nitrile glove (or any desired article), but in this case there may be no magnetic powder involved. In addition, when making the magnetic backplating embodiment there may be little or no difference in the design of the plastic housing to create a 4 or 7 solenoid model (described below) versus a 1 solenoid model because the change then is in the number of actuators inserted below the backplating.

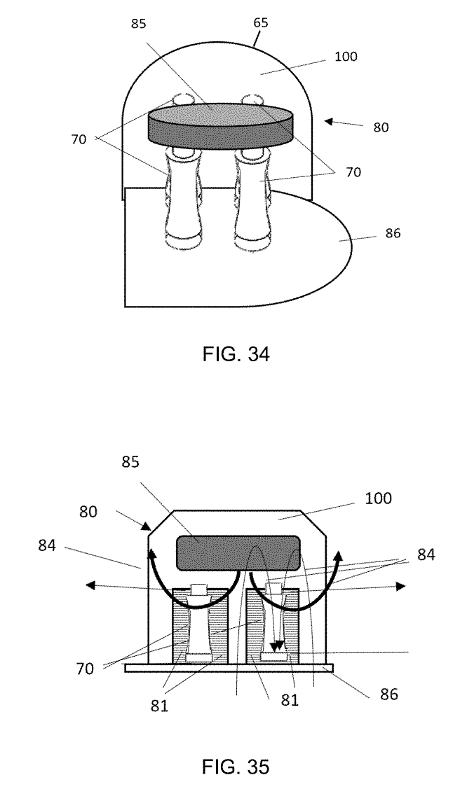

In FIGS. 27-41, component 70 represents the combination plastic bodies of the solenoid cores and the magnetic wire wrapped around them. There may be an encapsulating plastic frame that houses the solenoids and keeps them contained so that they do not rotate with the magnetic field but stay upright or push downward in the cases where this is desirable. Item 85 of FIG. 34 represents a membrane coated in magnetic particles (for example neodymium-based material) that are anisotropically magnetized on application to allow the solenoids to exert force on the membrane by creating an opposing magnetic field and forcing the membrane down and against the skin (the solenoids are secured to the inner roof of the actuator and thus cannot move). In contrast, item 85 of FIG. 35 represents an intact neodymium magnet which is used as a back-plate from which the unsecured solenoids 70 push off when they create their magnetic fields. FIG. 35 shows the force lines of the proposed solenoids and how they may interact with the magnetic backplating to produce pressure output.

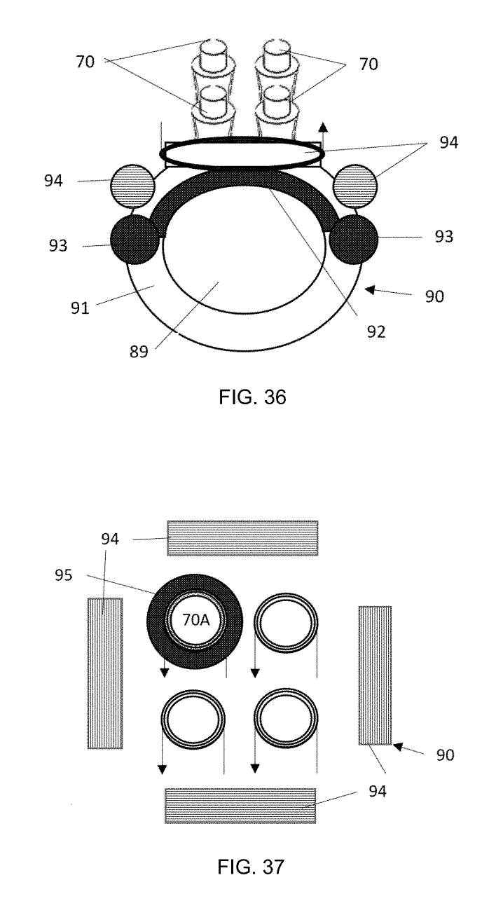

FIG. 36 represents an example ferrofluid system, ring 91 serves to attach the system to the finger by acting as a ring (i.e. the finger passes through opening 89, inside of this plastic ring are hollow spaces designed to contain the ferrofluid (dark shaded portions 93 in FIG. 36). Cylindrical items 70 represent the wrapped solenoids which can exert magnetic fields on the ferrofluid and cause it to pool in certain positions and exert pressure this way. FIGS. 37-41 demonstrate examples of pooling of ferrofluid in different locations according to the activation of different solenoids in the array.

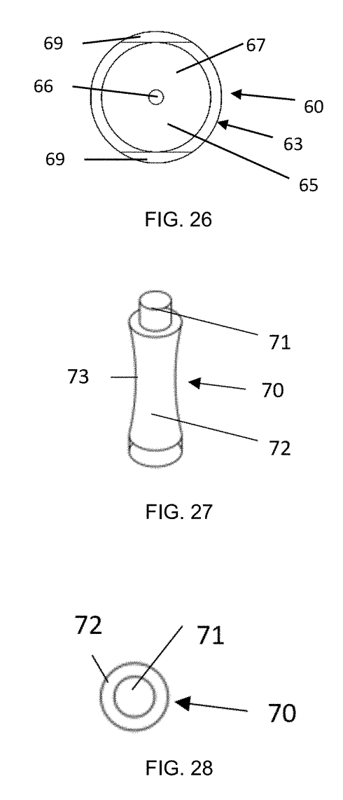

Referring now in more detail to FIGS. 20-26, there is shown a variable fingertip base 60 according to aspects described herein. The variable fingertip base 60 may be designed and adapted for use on a portion of a user's finger, for example the fingertip of a human operator. In one aspect, the variable fingertip base 60 serves a similar role as the cap 20 shown in FIGS. 11-13, in that the variable fingertip base 60 at least partially contains/houses actuator components and serves to hold the components securely to a surface of a glove or other article worn by the user. The variable fingertip base 60 can be designed in a number of variations depending on the design of the system and the number of pressure points desired in the assembly. FIGS. 20-24 show a seven pressure-point base 61 (see FIG. 24; seven indents/slots/receptacles 66), while FIG. 25 shows a four pressure-point base 100 and FIG. 26 shows a one pressure-point base 63. A difference between the seven pressure-point base 61 as compared to the four and one pressure-point bases 100, 63 (respectively) are the lack of variable levels 64 on the roof 65 of the base 60; all the pressure-point bases 61, 100, 63 are distinguished by their number of solenoid attachment points 66 which determine the number of solenoid cores 70 that are housed in the inner space 67 of the base 60 which gives the number of pressure points that the base 60 can create. In realizations of this system where the solenoid cores 70 are not directly attached to the variable fingertip base 60, the number of solenoid attachment points 66 may be irrelevant and a magnet can be placed against the roof 65 of the base 60 with these points 66 serving as glue holes for gluing the magnet to the roof 65 to increase adhesion of the magnet.

The outside of the variable fingertip base 60 has a curvature 68 (see FIGS. 20-23) that increases, and may be configured for, comfort should the base 60 come into contact with the user's hand or other portion of the body. Example variable fingertip bases 60 also can include wings 69 on one or more sides (e.g. two opposing sides in these examples) to attach more securely to the glove (or other article worn by the user) and contour to the shape of the finger (or other body part), increasing the ease with which the base 60 can be attached to the glove or other article.

Referring now in more detail to FIGS. 27-29, there is shown a solenoid core 70 according to aspects described herein. The solenoid core 70 may typically be designed to be integrated into a base 60 that may or may not have attachment points 66 meant to accommodate at least a portion of the solenoid core, e.g. a tip or end portion 71 that is inserted into or otherwise engages with attachment points 66 to at least partially secure the solenoid core with/against the base 60. Thus, the solenoid core 70 in this design has an attachment point 71 in examples where it is to be attached to a base 60. In examples where the solenoid core 70 remains unattached, then the attachment point 71 can serve as a point for a winding machine to grip during manufacture. The body 72 of the solenoid core 70 may be cylindrical in nature to best concentrate the magnetic field that the wires around it generate. The body 72 of the solenoid core 70 may also have a concave curvature 73 which allows for a greater number of windings of the wire to be put around the body 72, and assists in the winding process by causing the wire to wrap more times toward the center of the curvature 73 before the windings are caused to work outward from the center of the curvature and wrap around portions of the body 72 closer to the top and bottom of the solenoid core 70. In contrast to the construction of the variable fingertip base 60, the solenoid core 70 may be constructed of plastic or other non-magnetic material for proper function when in close proximity to the magnets in the system. If the solenoid core 70 is not constructed of a non-magnetic material, then the solenoid wire may need to overpower the magnetic polarity induced in the solenoid core material before the solenoid can act on the magnet, which might greatly reduce the efficiency of the system. It is, however, envisioned that it is possible that the solenoid core may be constructed, at least in part, of an at least partially magnetic material if desired.

Referring now in more detail to FIGS. 30-35, there are shown a number of views of aspects described herein on two different variations on the creation of the multiple pressure point system 80 that may be used in aspects described herein. FIGS. 30-32 depict top-down views of a one pressure-point base 63, four pressure-point base 100, and seven pressure-point base 61, respectively. In these figures, solenoid cores 70 are shown wrapped in magnetic wire 81 to create a solenoid. Each solenoid may be independently controlled using one or more MOSFET circuits shown previously, so that each solenoid can be independently activated and therefore can act as an independent pressure point, varying the pressure it exerts independent of the other solenoids. FIG. 33 shows an example multiple pressure point system 80 that utilizes a magnetic membrane 82 to convey pressure to a user 83 (83 being a portion of a user's finger, with system 80 sitting thereon) at different points. The magnetic membrane 82 here can be an elastic or rubbery membrane to which a magnetic material (e.g. powder) is attached/affixed/adhered in such a way that during the binding process, the individual particles in the magnetic powder are all made to orient their magnetic fields in a same/common direction (this is accomplished typically by adhering the particles to the membrane while they are in the presence of a strong magnetic field). This creates an anisotropically magnetized membrane 82 which the solenoid cores 70 can repel by creating an opposing magnetic field. One benefit to using a magnetic membrane 82 is an increase in the ability to create pressure gradients across the surface of the skin of the user 83, which can be useful in simulating certain sensations and heightening the level of realism that the system 80 can convey to the user.

Another example of the multiple pressure point system 80 is shown at rest in FIG. 34 and in operation with characteristic magnetic field lines 84 in FIG. 35. This variation uses a magnetic back plating 85 which the solenoid cores 70 push off from when they produce opposing magnetic fields 84. In contrast to the magnetic membrane embodiment (FIG. 33), FIGS. 34-35 with magnetic back plating 85 has the solenoid cores 70 unattached to the roof 65 of the variable fingertip base 60 with the magnetic back plate 85 instead being attached to the roof 65. This differs from almost all the other discussed realizations in that the solenoid cores 70 move instead of remaining stationary and coercing a magnet to move, as occurs in other embodiments discussed herein. To create this system 80, the solenoid cores 70 are attached/coupled to a thin glove membrane 86 (such as nitrile or latex) using, e.g., adhesive, and then the variable fingertip base 60 containing the magnetic back plating 85 is attached over the solenoid cores 70. The solenoid cores 70 are then forced down when they are activated because of the magnetic back plates 85 opposing magnetic field 84. The downward force flexes the glove membrane 86 and creates pressure on the underlying skin of the user.

Referring now to another aspect, FIGS. 36-41 show a dynamic ferrofluid pressure system 90 which may be put on the fingertip with a ring structure 91 (FIG. 36) allowing the system 90 to be worn like a ring. Within this ring structure 91 (seen from the front in FIG. 36) are contained a rubber inner lining 92 on an operating surface of the system 90 which is connected to a number of storage reservoirs 93. These reservoirs 93 store ferrofluid. When worn, the ring structure 91 is designed to use the person's finger to keep the rubber inner lining 92 flush against the inner portion of the ring 91. This forces the ferrofluid to leave the space above the rubber inner lining and pushes the fluid back into the storage reservoirs 93 because of the pressure from the skin of the finger until the ferrofluid is acted upon by the magnetic fields of the solenoid cores 70 or by the outer ring solenoids 94 which function to increase the variability in the pressure patterns that the system 90 can create as well as pull ferrofluid into and out of the storage reservoirs 93. One advantage of the ferrofluid system 90 is that with proper control the system 90 can simulate fluid motion and give a greater range of sensation than some of the other embodiments. This system 90 may be harder to control in general. Where other solenoid system embodiments could create pressure using pulse width modulation (PWM) to control the system, the ferrofluid system 90 may work via very specific sinusoidal varying of the voltage applied to the solenoids to create a magnetic field that oscillates such that it causes propagation in the alignment of the ferrofluid's magnetic poles. This propagation then moves the fluid in a particular direction. It may be much more difficult to implement and control then the other embodiments and require more power to operate, making the system 90 potentially less efficient.

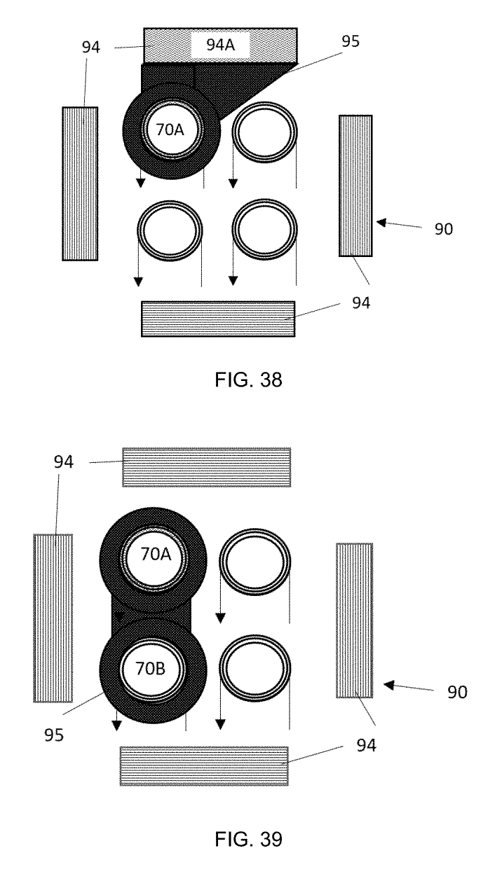

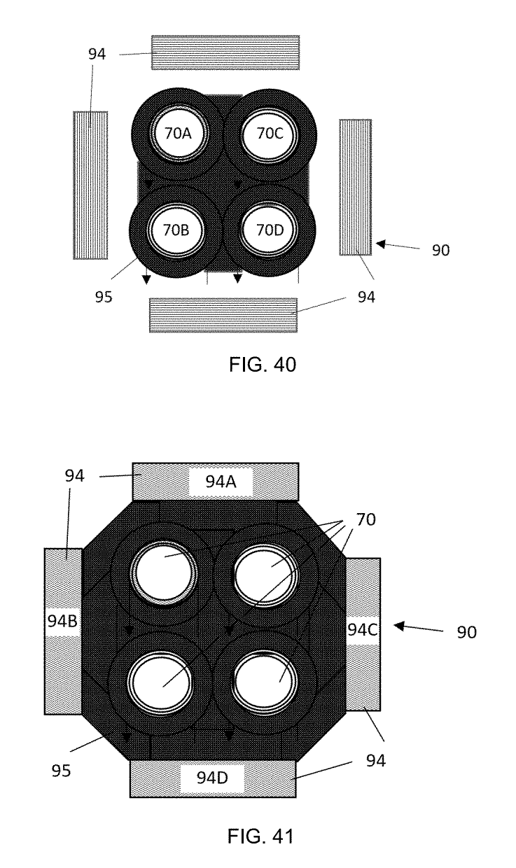

FIGS. 37-41 show a number of examples of ferrofluid migration/movement 95 in the system 90 based on the activation of various solenoids 70 and/or 94. FIG. 37 depicts ferrofluid movement 95 based on activation of solenoid core 70A. FIG. 38 shows ferrofluid movement 95 based on the activation of solenoid core 70A and one outer ring solenoid 94A. FIG. 39 shows ferrofluid movement 95 based on the activation of two solenoid cores 70A, 70B. FIG. 40 shows ferrofluid movement 95 based on the activation of solenoid cores 70A, 70B, 70C and 70D. FIG. 41 shows ferrofluid movement 95 based on the activation of solenoid cores 70A, 70B, 70C and 70D, and outer ring solenoids 94A, 94B, 94C, 94D.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

Accordingly, the following present just some example embodiments of aspects described herein:

A1. A system for providing tactile sensation, the system comprising: one or more actuators adapted to be proximate to the skin, each of the one or more actuators comprising: a deflectable armature; and a coiled wire adapted to deflect the armature in response to an electrical signal; wherein the deflected armature applies at least load to the skin of the user.

A2. The system as recited in A1, wherein the system further comprises a plunger that is deflectable in response to the solenoid.

A3. The system as recited in A1 or A2, wherein the system further comprises a bobbin adapted to receive wires of the solenoid.

A4. The system as recited in A3, wherein the bobbin comprises a hole adapted to receive the plunger.

A5. The system as recited in A4, wherein the bobbin comprises a hollow cylindrical structure.

A6. The system as recited in any one of A1 to A5, wherein the cap comprises a hollow cylindrical structure adapted to receive the armature.

A7. The system as recited in A6, wherein the cap is adapted to contain the actuator pieces within a hollow cylindrical structure.

A8. The system as recited in any one of A1 to A7, wherein the armature comprises a cylindrical metallic/magnetic body.

A9. The system as recited in any one of A1 to A8, wherein the system further comprises an antagonistic device adapted to restrict deflection of the armature.

A10. The system as recited in A9, wherein the antagonistic device comprises one of a spring and an elastomeric membrane.

A11. The system as recited in any one of A1 to A10, wherein the system further comprises a glove adapted to receive the one or more actuators.

A12. The system as recited in any one of A1 to A11, wherein the system further comprises a control system configured to operate the one or more actuators.

A13. A method for providing tactile sensation to a user, the method comprising: mounting one or more actuators to transmit a load to the skin of a user, each of the one or more actuators comprising: a cap having an inner space to contain the armature and solenoid; a deflectable armature mounted in the cap that either directly or through a plunger exerts force and creates pressure on the user; and a solenoid adapted to deflect the armature in response to an electrical signal; wherein contact between the deflected armature and the person's skin transmits at least load to the skin of the user; activating the solenoid and thereby deflecting the armature; and transmitting the deflection of the armature as a load either by itself or through a plunger to the skin of the user.

A14. The method as recited in A13, wherein activating the solenoid comprises energizing the solenoid with an electric current.

A15. The method as recited in A13 or A14, wherein transmitting the deflection of the armature to the skin comprises deflecting a plunger with the solenoid and contacting the armature with the plunger.

A16. The method as recited in any one of A13 to A15, wherein transmitting the deflection of the armature as a load on the skin comprises deflecting the cap with the armature wherein the cap imposes the load on the skin.

A17. The method as recited in A13, wherein mounting the one or more actuators comprises mounting the one or more actuators to an apparel wearable by the user.

A18. The method as recited in A14, wherein the apparel comprises a glove.

A19. The method as recited in any one of A13 to A18, wherein the method further comprises controlling operation of the solenoid with a controller.

A20. The method as recited in A19, wherein controlling the operation of the solenoid with a controller comprises controlling the operation of the controller in response to an input signal to the controller.

A21. An actuator for providing tactile sensation to a user, the actuator comprising: a cap having an inner space to contain the armature ; a deflectable armature mounted in the cap; and a solenoid adapted to deflect the armature in response to an electrical signal; wherein contact between the deflected armature and the skin of the user transmits at least load to the skin of the user.

A22. The actuator as recited in A21, wherein the actuator further comprises a plunger that is deflectable in response to the solenoid.

A23. The actuator as recited in A21 or A22, wherein the actuator further comprises a bobbin adapted to receive wires of the solenoid.

A24. The actuator as recited in A23, wherein the bobbin comprises a hole adapted to receive the plunger.

A25. The actuator as recited in A24, wherein the bobbin comprises a hollow cylindrical structure.

A26. The actuator as recited in any one of A21 to A25, wherein the cap comprises a hollow cylindrical structure adapted to receive the armature.

A27. The actuator as recited in A26, wherein the cap is designed to contain the actuator components and prevent them from moving away from the surface the cap is attached to.

A28. The actuator as recited in any one of A21 to A27, wherein the armature comprises a cylindrical metallic/magnetic body.

A29. The actuator as recited in any one of A21 to A28, wherein the actuator further comprises an antagonistic device adapted to restrict deflection of the armature.

A30. The actuator as recited in A29, wherein the antagonistic device comprises one of a spring and an elastomeric membrane.

A31. The actuator as recited in any one of A21 to A30, wherein the actuator further comprises a control system configured to operate the one actuator.

Although various embodiments are described above, these are only examples. For example, computing environments of other architectures can be used to incorporate and use one or more embodiments.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

1. A system for providing tactile sensation, the system comprising:
one or more actuators configured for positioning proximate a surface of a body of a user, wherein each actuator of the one or more actuators comprises:
a deflectable armature; and
a coiled wire configured to deflect the armature, based on an electrical signal, to apply pressure to the surface of the body of the user.

2. The system of claim 1, wherein each actuator of the one or more actuators is configured to apply a respective variable amount of pressure to the surface of the body of the user based on deflection of the armature of the actuator.

3. The system of claim 1, wherein an actuator of the one or more actuators further comprises a plunger with which the armature of the actuator physically engages based on deflection of the armature, to deflect the plunger to apply the pressure to the surface of the body of the user.

4. The system of claim 3, wherein an actuator of the one or more actuators further comprises a bobbin around which the coiled wire is coiled, and wherein the bobbin comprises a hole configured to receive the plunger.

5. The system of claim 1, wherein the armature of an actuator of the one or more actuators comprises a cylindrical metallic body.

6. The system of claim 1, wherein an actuator of the one or more actuators further comprises an antagonistic device configured to restrict deflection of the armature.

7. The system of claim 6, wherein the antagonistic device comprises a spring or an elastomeric membrane.

8. The system of claim 1, further comprising a glove to which the one or more actuators are attached, wherein attachment of the one or more actuators to the glove is configured for the one or more actuators to provide the pressure to the surface of the body of the user when the glove is worn by the user.

9. The system of claim 1, further comprising a control system configured to operate the one or more actuators, the operation of the one or more actuators comprising delivering a respective electrical signal to each actuator of the one or more actuators to deflect the armature of the actuator and apply the respective pressure to the surface of the body of the user.

10. A method for providing tactile sensation to a user, the method comprising:
controlling one or more actuators to apply, for each actuator of the one or more actuators, a respective pressure to a surface of a body of a user, wherein each actuator of the one or more actuators comprises:
a deflectable armature; and
a coiled wire configured to deflect the armature, based on an electrical signal, to apply the respective pressure to the surface of the body of the user, wherein the controlling comprises, for each actuator of the plurality of actuators, activating deflection of the respective armature to apply the respective pressure.

11. The method of claim 10, wherein the activating deflection of the armature comprises energizing the coiled wire with an electric current.

12. The method of claim 10, further comprising mounting the one or more actuators to an apparel configured to be worn by the user.

13. The method of claim 12, wherein the apparel comprises a glove.

14. A system for providing tactile sensation, the system comprising:
one or more actuators configured for positioning proximate a surface of a body of a user, wherein each actuator of the one or more actuators comprises:
one or more solenoids configured for activation, by at least one electrical signal, to generate, for each solenoid of the one or more solenoids, a respective magnetic field and apply a corresponding pressure to the surface of the body of the user; and
a housing at least partially containing the one or more solenoids, wherein activation of each solenoid of the one or more solenoids is independently controllable from activation of any other solenoids of the one or more solenoids.

15. The system of claim 14, wherein a solenoid of the one or more solenoids comprises an elongated cylindrical body comprising plastic material wrapped in metal wire, and wherein the corresponding pressure comprises a variable amount of pressure against the surface of the body of the user.

16. The system of claim 14, wherein the one or more actuators are affixed to an article configured to be worn by a user, and the corresponding pressure for each solenoid of the one or more solenoids is for application through the article to the surface of the body of the user.

17. The system of claim 14, wherein the housing of an actuator of the one or more actuators comprises curved portions configured to conform to a contour of the surface of the body of the user when the actuator is operatively positioned proximate the surface of the body of the user.

18. The system of claim 14, further comprising magnetic material disposed on an article configured to be worn by the user such that the magnetic material sits between the surface of the body of the user and an actuator of the one or more actuators, wherein a solenoid of the one or more solenoids of an actuator, of the one or more actuators, is configured to repel, based on the generated respective magnetic field, at least a portion of the magnetic material toward the surface of the skin of the user to provide the corresponding pressure to the surface of the body of the user.

19. The system of claim 18, wherein the solenoid is secured to an inner portion of the housing of the actuator and the actuator is secured to the article, wherein movement of the solenoid away from the magnetic material is impeded by the housing to which the solenoid core is secured.

20. The system of claim 14, further comprising magnetic material disposed proximal an inner portion of the housing of an actuator of the one or more actuators, wherein the magnetic material is configured to repel, toward the surface of the body of the user, a solenoid of the one or more solenoids of the actuator based on activation of the solenoid, to produce the corresponding pressure to the surface of the body of the user.
